(19) United States
(12) Patent Application Publication
(10) Pub. No.: US 2026/0223122 A1
(43) Pub. Date: Jul. 30, 2026

(54) METHOD FOR WIRELESS COMMUNICATION, TERMINAL DEVICE, AND NETWORK DEVICE

(71) Applicant: Quectel Wireless Solutions Co., Ltd., Shanghai (CN)

(72) Inventors: Qufang HUANG, Shanghai (CN); Jin LIU, Shanghai (CN); Zheng ZHAO, Shanghai (CN)

(73) Assignee: Quectel Wireless Solutions Co., Ltd., Shanghai (CN)

(21) Appl. No.: 19/630,290

(22) Filed: Mar. 26, 2026

Related U.S. Application Data
(63) Continuation of application No. PCT/CN2024/114335, filed on Aug. 23, 2024.

(51) Int. Cl. H04W 72/21; H04L 5/00

(52) U.S. Cl. CPC H04W 72/21; H04L 5/0007

(57) ABSTRACT

A method for wireless communication includes: receiving, by a terminal device, first indication information transmitted by a network device, where the first indication information is used to indicate whether the terminal device is allowed to multiplex uplink control information (UCI) from a physical uplink control channel (PUCCH) onto a physical uplink shared channel (PUSCH) for transmission in a first time period of an orthogonal cover code (OCC) period. In embodiments of the disclosure, the network device transmits first indication information to the terminal device to indicate whether the terminal device is allowed to multiplex the UCI from the PUCCH onto the PUSCH for transmission in the first time period of the OCC period.

### CROSS-REFERENCE TO RELATED APPLICATIONS

This application is a continuation of International Application No. PCT/CN2024/114335, filed on Aug. 23, 2024, the content of which is incorporated herein by reference in its entirety.

### TECHNICAL FIELD

This application relates to the field of communications technology, and more particularly, to a method for wireless communication, a terminal device, and a network device.

### BACKGROUND

In some scenarios, a terminal device may multiplex uplink control information (UCI) from a physical uplink control channel (PUCCH) onto a physical uplink shared channel (PUSCH) for transmission. However, in conventional UCI multiplexing schemes, the network device is unaware of the UCI multiplexing status at the terminal device side, which may result in decoding failure at the network device.

### SUMMARY

The present disclosure provides a method for wireless communication, a terminal device, and a network device. Various aspects of the present disclosure are described below.

In a first aspect, a method for wireless communication is provided. The method includes: receiving, by a terminal device, first indication information transmitted by a network device, where the first indication information is used to indicate whether the terminal device is allowed to multiplex uplink control information (UCI) from a physical uplink control channel (PUCCH) onto a physical uplink shared channel (PUSCH) for transmission in a first time period of an orthogonal cover code (OCC) period.

In a second aspect, a method for wireless communication is provided. The method includes: transmitting, by a network device, first indication information to a terminal device, where the first indication information is used to indicate whether the terminal device is allowed to multiplex uplink control information (UCI) from a physical uplink control channel (PUCCH) onto a physical uplink shared channel (PUSCH) for transmission in a first time period of an orthogonal cover code (OCC) period.

In a third aspect, a terminal device is provided. The terminal device includes: a receiving unit, receiving first indication information transmitted by a network device, where the first indication information is used to indicate whether the terminal device is allowed to multiplex uplink control information (UCI) from a physical uplink control channel (PUCCH) onto a physical uplink shared channel (PUSCH) for transmission in a first time period of an orthogonal cover code (OCC) period.

In a fourth aspect, a network device is provided. The network device includes: a transmitting unit, transmitting first indication information to a terminal device, where the first indication information is used to indicate whether the terminal device is allowed to multiplex uplink control information (UCI) from a physical uplink control channel (PUCCH) onto a physical uplink shared channel (PUSCH) for transmission in a first time period of an orthogonal cover code (OCC) period.

In a fifth aspect, a terminal device is provided. The terminal device includes a processor, a memory, and a communications interface. The memory is configured to store one or more computer programs. The processor is configured to invoke the computer programs stored in the memory, to cause the terminal device to perform part or all of the steps of the method in the first aspect.

In a sixth aspect, a network device is provided. The network device includes a processor, a memory, and a transceiver. The memory is configured to store one or more computer programs. The processor is configured to invoke the computer programs stored in the memory, to cause the network device to perform part or all of the steps of the method in the second aspect.

In a seventh aspect, a communications system is provided according to an embodiment of the disclosure. The communications system includes the terminal device and/or the network device described above. In another embodiment, the communications system may further include other devices that interact with the terminal device or the network device according to embodiments of the present disclosure.

In an eighth aspect, a computer-readable storage medium is provided. The computer-readable storage medium stores a computer program which, when executed, causes a communications device (for example, a terminal device or a network device) to perform part or all of the steps of the method described in the foregoing aspects.

In a ninth aspect, a computer program product is provided. The computer program product includes a non-transitory computer-readable storage medium storing a computer program, the computer program being operable to cause a communications device (for example, a terminal device or a network device) to perform part or all of the steps of the method described in the foregoing aspects. In some embodiments, the computer program product may be a software installation package.

In a tenth aspect, a chip is provided according to an embodiment of the disclosure. The chip includes a memory and a processor, the processor being configured to invoke a computer program from the memory and run the same, to perform part or all of the steps of the methods described in the foregoing aspects.

In embodiments of the present disclosure, a network device transmits first indication information to a terminal device to indicate whether the terminal device is allowed to multiplex UCI from a PUCCH onto a PUSCH for transmission in a first time period of an OCC period. Compared with conventional UCI multiplexing schemes, the terminal device can report the UCI in the OCC period based on the first indication information, and the network device can decode a received information sequence based on the first indication information (for example, by applying different decoding strategies for terminal devices corresponding to different first indication information), which helps improve a decoding success rate.

### BRIEF DESCRIPTION OF THE DRAWINGS

FIG. 1 illustrates a wireless communications system 100 to which embodiments of the present disclosure are applied.

FIG. 2 is an example diagram illustrating a cross-slot OCC technique.

FIG. 3 is a schematic flowchart illustrating a method for wireless communication according to an embodiment of the present disclosure.

FIG. 4 is an example diagram illustrating a received information sequence at a network device.

FIG. 5 is an example diagram illustrating a scheme related to first indication information at a network device side.

FIG. 6 is an example diagram illustrating a scheme related to the first indication information at a terminal device side.

FIG. 7 is a schematic diagram illustrating a terminal device according to an embodiment of the present disclosure.

FIG. 8 is a schematic diagram illustrating a network device according to an embodiment of the present disclosure.

FIG. 9 is a schematic structural diagram illustrating a communications apparatus according to an embodiment of the present disclosure.

### DETAILED DESCRIPTION OF THE EMBODIMENTS

The technical solutions of the present disclosure are described below with reference to the accompanying drawings.

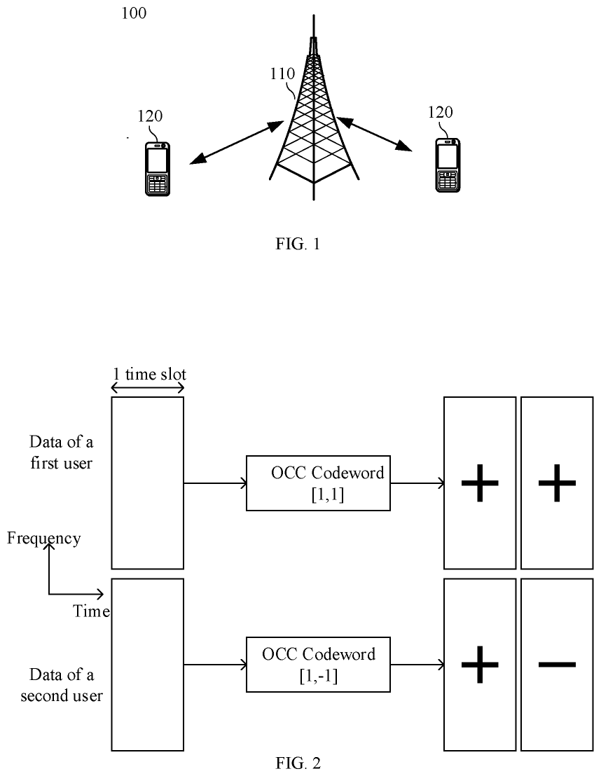

FIG. 1 illustrates a wireless communications system 100 to which embodiments of the present disclosure are applied. The wireless communications system 100 may include a network device 110 and a terminal device 120. The network device 110 is a device that communicates with the terminal device 120. The network device 110 can provide communication coverage for a specific geographic area and can communicate with terminal devices 120 located within its coverage.

FIG. 1 exemplarily illustrates one network device and two terminal devices. Optionally, the wireless communications system 100 may include multiple network devices, and the coverage of each network device may include another quantity of terminal devices. Embodiments of the present disclosure are not limited in this regard.

Optionally, the wireless communications system 100 may further include other network entities, such as a network controller or a mobility management entity. Embodiments of the present disclosure are not limited in this regard.

It should be understood that the technical solutions of the present disclosure can be applied to various communications systems, such as a fifth generation (5G) system or a new radio (NR) system, a long term evolution (LTE) system, an LTE frequency division duplex (FDD) system, and an LTE time division duplex (TDD) system. The technical solutions provided by the present disclosure may also be applied to future communications systems, such as a sixth generation mobile communications system, and a satellite communications system.

In the embodiments of the present disclosure, a terminal device may also be referred to as user equipment (UE), an access terminal, a user unit, a user station, a mobile station (MS), a mobile terminal (MT), a remote station, a remote terminal, a mobile device, a user terminal, a terminal, a wireless communications device, a user agent, or a user apparatus. The terminal device in the embodiments of the present disclosure may refer to a device that provides voice and/or data connectivity to a user and can be used to connect people, objects, and machines, such as handheld devices or in-vehicle devices with wireless connectivity. The terminal device according to the embodiments of the present disclosure may include a mobile phone, a tablet computer (Pad), a laptop, a palm computer, a mobile internet device (MID), a wearable device, a virtual reality (VR) device, an augmented reality (AR) device, a wireless terminal for industrial control, a wireless terminal for self-driving, a wireless terminal for remote medical surgery, a wireless terminal for smart grid, a wireless terminal for transportation safety, a wireless terminal for smart city, a wireless terminal for smart home, and the like. Optionally, the UE may also function as a base station. For example, the UE may act as a scheduling entity, providing sidelink signals between UEs in scenarios such as vehicle-to-everything (V2X) or Device-to-Device (D2D) communication. For instance, a cellular phone and a vehicle may communicate with each other using sidelink signals, or a cellular phone may communicate with smart home devices without relaying communication signals by a base station.

In the embodiments of the present disclosure, a network device may be a device configured to communicate with a terminal device. The network device may also be referred to as an access network device or a radio access network device, such as a base station. The network device in the embodiments of the present disclosure may refer to a radio access network (RAN) node (or device) that provides access for terminal devices to a wireless network. A base station can broadly cover or be replaced by various names, including but not limited to: NodeB (NodeB), evolved NodeB (eNB), next generation NodeB (gNB), relay station, access point, transmitting and receiving point (TRP), transmitting point (TP), master eNodeB (MeNB), secondary eNodeB (SeNB), multi-standard radio (MSR) node, home base station, network controller, access node, wireless node, access point (AP), transmitting node, transceiver node, baseband unit (BBU), remote radio unit (RRU), active antenna unit (AAU), remote radio head (RRH), central unit (CU), distributed unit (DU), positioning node, or the like. A base station may be a macro base station, a micro base station, a relay node, a donor node, or a similar device, or a combination thereof. A base station may also refer to a communications module, a modem, or a chip configured within the foregoing devices or apparatuses. Additionally, a base station may include devices functioning as a mobile switching center, or devices serving base station functions in device-to-device D2D communication, vehicle-to-everything (V2X) communication, machine-to-machine (M2M) communication, a device on the network side in 6G networks, or a device serving base station functions in future communications systems. A base station may support networks using the same or different access technologies. The embodiments of the present disclosure do not limit the specific technology or form of the network device.

A base station may be stationary or mobile. For example, a helicopter or unmanned aerial vehicle may be configured to serve as a mobile base station, with one or more cells moving according to the position of the mobile base station. In other examples, a helicopter or unmanned aerial vehicle may be configured to function as a device that communicates with another base station.

In some deployments, the network device of the present disclosure may refer to a central unit (CU) or a distributed unit (DU). Alternatively, the network device includes both a CU and a DU. A gNB may further include an AAU.

The network device and the terminal device may be deployed on land, including indoors or outdoors, handheld or in vehicles; they may also be deployed on water surfaces, or in aerial platforms such as airplanes, balloons, or satellites. Embodiments of the present disclosure are not limited to any particular deployment scenario for the network device and the terminal device.

It should be understood that all or part of the functions of the communications devices described herein may be implemented by software executing on hardware, or through virtualized functions instantiated on a platform (e.g., a cloud platform).

### UCI Multiplexing

Broadly, non-terrestrial networks (NTN) refer to all networks involving aerial or spaceborne platforms, including satellite communications networks, high-altitude platform systems, and air-to-ground networks. In the following description, the NTN technology particularly refers to low-earth-orbit satellite communications network technologies. With the development and proliferation of the NTN technology, an increasing number of devices will access NTNs, resulting in continuously growing uplink data traffic and increasing demands for NTN service continuity and stability. Accordingly, NTNs have an ever-growing need for enhanced uplink capacity.

The OCC technology is a spreading and coding technique used in wireless communication. The technique generates a set of orthogonal code sequences to spread and encode transmitted signals, thereby improving system spectral efficiency and interference resistance. In NTN, the OCC technology has been applied to the PUCCH. Results show that, by performing OCC multiplexing across different antenna ports of terminal devices within the same code division multiplexing (code division multiplexing, CDM) group, uplink capacity in the NTN can be effectively enhanced. This demonstrates the feasibility of OCC multiplexing for enhancing NTN uplink capacity. Currently, OCC schemes include the cross-symbol OCC, the cross-slot OCC, and the intra-symbol OCC.

The specific implementation process of cross-slot OCC is illustrated in FIG. 2. The total number of multiplexed terminal devices is M, and each time slot is repeated M times. Taking M=2 and the use of Walsh (Walsh) sequences to generate OCC codewords as an example, the resulting OCC codeword set is {[w₀ w₁], [w₀′ w₁′]}={[1 1], [1−1]}. In this example, an original single time slot is repeated twice in the time domain. Then, the data of a first user and the data of a second user for each of the repeated time slots are superimposed with the OCC codewords [1, 1] and [1, −1], respectively.

According to relevant specifications (such as the NR specifications) in 3rd generation partnership project (3GPP), UCI includes three types of information: a scheduling request (SR), a hybrid automatic repeat request acknowledgement (HARQ-ACK), and channel state information (CSI). HARQ-ACK and CSI can be transmitted together with uplink shared channel (UL-SCH) data on PUSCH. When the uplink channels for transmitting UCI overlap in the time domain, the UCI needs to be multiplexed onto a single uplink channel for transmission. According to the provisions of relevant protocols (for example, TS 38.213), if a terminal device (e.g., UE) transmits one or more multi-slot PUSCHs scheduled by downlink control information (DCI) format 0_1, and the PUCCH on which single-slot HARQ-ACK and/or CSI is transmitted by the terminal device overlaps in one or more time slots with the PUSCH, and the PUSCH transmission satisfies the UCI multiplexing timing conditions, then the terminal device multiplexes HARQ-ACK and/or CSI onto the PUSCH transmission in one or more slots. Accordingly, part of the UCI can be transmitted on the PUSCH. The specific rules are as follows.

If a PUCCH carrying HARQ-ACK and CSI overlaps in time domain with a PUSCH carrying only UL-SCH data, the terminal device transmits the HARQ-ACK and CSI on the PUSCH.

If a PUCCH carrying HARQ-ACK and CSI overlaps in time domain with a PUSCH carrying UL-SCH data and non-periodic CSI, the terminal device multiplexes the HARQ-ACK onto the PUSCH for transmission, and discards the CSI for the PUCCH.

If a PUCCH carrying HARQ-ACK and CSI overlaps in time domain with a PUSCH carrying CSI, the terminal device multiplexes HARQ-ACK onto the PUSCH for transmission, and discards the CSI for the PUCCH.

In addition, current specifications support repeated transmissions of the PUSCH. The type of PUSCH repetitions include, for example, repetition Type A and repetition Type B. Repetition Type A is slot-level based, in which each slot uses the same symbol-level allocation. Repetition Type B is sub-slot-level (or symbol-level) based, and is mainly applicable to low-latency scenarios for ultra-reliable low-latency communications (URLLC).

In current specifications, the OCC technology has been widely applied to PUCCH and PUSCH, achieving uplink capacity enhancement by enabling resource multiplexing across multiple terminal devices. Related meetings (such as radio access network (RAN) #116) have verified the feasibility of applying cross-slot OCC technology to PUSCH repetition Type A. However, in the current specifications, UCI is multiplexed only within a single slot and is not replicated across each slot of multi-slot PUSCH repetitions. Because PUSCH repetition do not include the same structure as PUSCH repetition carrying UCI, applying cross-slot OCC may fail to maintain the orthogonality between multiplexed terminal devices. To address this issue, in the latest RAN #117 meeting, several companies proposed a scheme to extend UCI multiplexing across all slots in an OCC period. Under current standards, however, a PUCCH carrying UCI (for example, UCI including HARQ-ACK or non-periodic CSI) may collide with PUSCH repetition, and this scheme cannot resolve the issue where a PUCCH overlaps with PUSCH repetition within an OCC period. During relevant meetings (e.g., RAN #117), this issue was analyzed, and a solution was proposed: if it can be detected before a certain OCC period that a PUCCH will overlap with PUSCH repetition, the terminal may either multiplex the UCI from the PUCCH onto all PUSCH repetitions in the OCC period, or discard all PUSCH repetitions and transmit the PUCCH; otherwise, the terminal discards the PUCCH. However, the drawback of this solution is that it fails to provide a suitable resolution for the scenario where a PUCCH overlaps with PUSCH repetition within a single OCC period. Specifically, if the PUCCH is discarded, important information may be caused to be lost; if only part of the UCI from the PUCCH is multiplexed onto PUSCH repetition, all of the information from UEs using this OCC sequence may be caused to not be decoded successfully at the network device, and if the UCI is deferred to be transmitted within the next OCC period, UCI reception delay may be caused to increase when the length of the OCC sequence is large. In summary, for PUSCH using cross-slot OCC, the current UCI multiplexing rules cannot ensure fast and reliable UCI reporting.

As described above, in certain scenarios, a terminal device may multiplex UCI from a PUCCH onto a PUSCH for transmission. However, under traditional UCI multiplexing rules, the network device is unaware of the UCI multiplexing status at the terminal device side, which may result in decoding failures at the network device.

For example, in scenarios where cross-slot OCC is applied to PUSCH repetition, if a terminal device multiplexes UCI from the PUCCH onto the PUSCH repetition, the network device does not know whether the UCI has been multiplexed by the terminal device onto the PUSCH. Because the PUSCH repetitions that do not carry multiplexed UCI have a different structure than the PUSCH repetition that carry the multiplexed UCI within an OCC period, the network device may be failed to decode a received information sequence using the same OCC codeword.

To solve the foregoing problem, embodiments of the present disclosure provide a method for wireless communication in which a network device transmits first indication information to a terminal device. The first indication information indicates whether the terminal device is allowed to multiplex UCI from a PUCCH onto a PUSCH for transmission in a first time period of an OCC period. Compared with conventional UCI multiplexing rules, the terminal device can report UCI in the OCC period based on the first indication information, and the network device can decode a received information sequence based on the first indication information (for example, by adopting different decoding strategies for terminal devices corresponding to different first indication information), which helps improve decoding success rate.

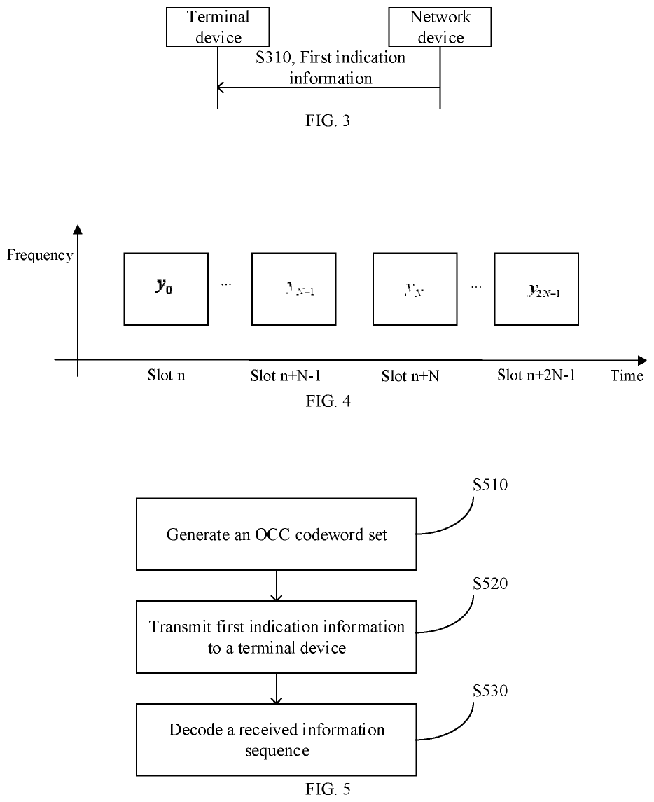

With reference to FIG. 3, the following introduces a method for wireless communication according to an embodiment of the present disclosure. FIG. 3 is a schematic flowchart illustrating a method for wireless communication according to an embodiment of the present disclosure. The method shown in FIG. 3 includes the following step S310.

In step S310, a network device transmits first indication information to a terminal device.

In some implementations, the first indication information is used to indicate whether the terminal device is allowed to multiplex UCI from a PUCCH onto a PUSCH for transmission in a first time period of an OCC period.

In some implementations, the first indication information is carried in a field. For example, the first indication information may be carried in a field α. When α is a first value, it indicates that the terminal device is allowed to multiplex the UCI from the PUCCH onto the PUSCH for transmission in the first time period of the OCC period. When α is a second value, it indicates that the terminal device is not allowed to multiplex the UCI from the PUCCH onto the PUSCH for transmission in the first time period of the OCC period. The first value and the second value are different. For example, the first value may be 0 and the second value may be 1. Alternatively, the first value may be 1 and the second value may be 0.

In some implementations, the network device may transmit the first indication information to one or more terminal devices. For example, the number of terminal devices is N_{S}. The first indication information corresponding to the N_{S} terminal devices is represented as [α₁, α₂ . . . α_{N}_{ₛ}] which indicates whether the N_{S} terminal devices are allowed to multiplex UCI from a PUCCH onto a PUSCH for transmission in the first time period of the OCC period. αᵢ has a value of 0 or 1. If αᵢ=1, it indicates that an i-th terminal device is allowed to multiplex UCI from the PUCCH onto the PUSCH for transmission in the first time period of the OCC period. If αᵢ=0, it indicates that an i-th terminal device is not allowed to multiplex UCI from the PUCCH onto the PUSCH for transmission in the first time period of the OCC period.

In some implementations, the number of terminal devices to which the network device transmits the first indication information may also be referred to as the “multiplexed terminal device number”.

In some implementations, the first indication information may be referred to as a “UCI multiplexing rule”.

In some implementations, the first indication information is determined by the network device based on UCI reporting requirements reported by the terminal devices. For example, the UCI reporting requirements reported by the terminal devices include a higher demand for reporting HARQ-ACK or CSI due to terminal device's high communication traffic. After the reported UCI reporting requirements is received from terminal devices, the first indication information, determined by the network device for terminal devices with high communication traffic, indicates that the terminal devices are allowed to multiplex UCI from the PUCCH onto the PUSCH for transmission in the first time period of the OCC period, while the first indication information, determined by the network device for terminal devices with low communication traffic, indicates that the terminal devices are not allowed to multiplex UCI from the PUCCH onto the PUSCH for transmission in the first time period of the OCC period. As another example, for an i-th terminal device with high communication traffic, the corresponding first indication information is αi, and the network device determines αi as 1. As another example, for an i-th terminal device with low communication traffic, the corresponding first indication information is αi, and the network device determines αi as 0. Based on the first indication information, the network device can decode information sequences transmitted by terminal devices that multiplex UCI onto the PUSCH without affecting the decoding of other terminal devices.

In some implementations, the aforementioned operation of multiplexing, by the terminal device, UCI from a PUCCH onto a PUSCH for transmission in a first time period of an OCC period may be construed to mean that the terminal device may perform the multiplexing in the first time period of each OCC period.

In some implementations, the aforementioned operation of multiplexing UCI from a PUCCH onto a PUSCH for transmission can be construed to mean that if the PUCCH carrying UCI collides with a PUSCH, the UCI from the PUCCH is transmitted on the PUSCH; or if the PUCCH carrying UCI overlaps with a PUSCH in the time domain, the UCI from the PUCCH is transmitted on the PUSCH.

In the embodiments of the present disclosure, there is no limitation on the UCI carried by the PUCCH. For example, the UCI may include HARQ-ACK and/or CSI.

In some implementations, the first indication information may be carried in first signaling.

In the embodiments of the present disclosure, there is no limitation on the first signaling. In some implementations, the first signaling may be a radio resource control (RRC) message. In other implementations, the first signaling may be a medium access control control element (MAC CE).

In some implementations, the first signaling may indicate an OCC codeword to the terminal device. In the embodiments of the present disclosure, the information indicating the OCC codeword and the first indication information may alternatively be carried on different signaling.

In some implementations, the OCC codeword for a terminal device is determined by a network device based on a UCI reporting requirement reported by the terminal device. For example, when the multiplexed terminal device number is N_{S}, the network device analyzes the UCI reporting requirement of each multiplexed terminal device, and allocates, to each terminal device according to the structure of codewords, an OCC codeword having a length of 2N (where N=2⁰, 2¹, 2², . . . ). The OCC codeword of an i-th terminal device is expressed as Sᵢ=[s_{i,1}, s_{i,2} . . . s_{i,2N}]. As another example, when the UCI reporting requirement of a terminal device is relatively high, the network device allocates to the terminal device an OCC codeword corresponding to the first time period that is significantly different from the OCC codewords corresponding to another time period of the OCC period, so as to facilitate decoding by the network device.

In some implementations, prior to transmitting the first indication information to the terminal device, the network device transmits an OCC codeword set to the terminal device. Correspondingly, upon receiving the OCC codeword set, the terminal device stores the OCC codeword set for subsequent use.

In some implementations, the OCC codeword set may be carried in an RRC configuration, and the network device transmits the OCC codeword set to the terminal device by means of an RRC message. For example, the network device may generate the OCC codeword set based on information such as the number of multiplexed terminals N_{S}, using a Walsh-Hadamard matrix generation method (or a discrete Fourier transformation (DFT) sequence generation method), and transmit the OCC codeword set to the terminal device through the RRC message.

In some implementations, first signaling directly indicates an OCC codeword to the terminal device. For example, the first indication information transmitted by the network device to an i-th terminal device is carried in the first signaling, and the first signaling carries an OCC codeword Sᵢ for the i-th terminal device.

In some other implementations, the first signaling indirectly indicates an OCC codeword to a terminal device. For example, an index of the OCC codeword for the terminal device is carried in the first signaling. Prior to transmitting the first signaling, the network device transmits the OCC codeword set to the terminal device. Upon receiving the OCC codeword set, the terminal device stores the OCC codeword set. After receiving the index of the OCC codeword carried in the first signaling, the terminal device queries the stored OCC codeword set to obtain the OCC codeword for the terminal device.

In some implementations, the first time period is a second half of the OCC period. For example, when the length of the OCC period is 2N (where N=2⁰, 2¹, 2², . . . ), the slot indices of the OCC period are [n, n+1, . . . , n+2N−1], and the indices of the first time period are [n+N,n+N+1, . . . , n+2N−1]. As another example, when the OCC period includes four slots, that is, a slot 0 to a slot 3, the first time period includes the slot 2 and the slot 3. By configuring the first time period as the second half of the OCC period, the terminal device may multiplex UCI on a PUSCH in the second half of the OCC period, without having to defer transmission of the UCI until a subsequent OCC period, thereby reducing UCI reporting latency.

In some implementations, a time at which a PUCCH collides with a PUSCH is within the OCC period, and the time is earlier than the first time period. For example, when the OCC period has a length of 2N (where N=2⁰, 2¹, 2², . . . ), the slot indices that the OCC period includes are [n, n+1, . . . , n+2N−1], and the slot indices of the first time period are [n+N, n+N+1, . . . , n+2N−1]. A slot in which a PUCCH carrying UCI collides with the PUSCH is denoted as n₀ (where n≤n₀≤n+N−1). As another example, when the OCC period includes four slots, i.e., a slot 0 through a slot 3, and the first time period is the time slot 3, the slot in which the PUCCH carrying UCI collides with the PUSCH may be the slot 0, the slot 1, or the slot 2. As another example, when the first time period includes the slot 2 and the slot 3, the slot in which the PUCCH and the PUSCH collide may be the slot 0 or the slot 1.

In some implementations, if the first indication information indicates that the terminal device is allowed to multiplex UCI onto the PUSCH for transmission in the first time period, the terminal device multiplexes the UCI onto the PUSCH for transmission in the first time period. That is, if the first indication information indicates that the terminal device is allowed to multiplex UCI onto the PUSCH for transmission in the first time period, and a PUCCH carrying UCI collides with the PUSCH, the terminal device may transmit the UCI from the PUCCH on the PUSCH in the first time period. For example, when the OCC period has a length of 2N (where N=2⁰, 2¹, 2², . . . ), the slot indices that the OCC period includes are [n, n+1, . . . , n+2N−1], and the slot indices of the first time period are [n+N, n+N+1, . . . , n+2N−1]. When the first indication information is α, and α=1 indicates that the terminal device is allowed to multiplex UCI onto the PUSCH for transmission in the first time period, and a PUCCH carrying UCI collides with the PUSCH in a slot n₀ (where n≤n₀≤n+N−1), the terminal device may multiplex the UCI of the PUCCH onto the PUSCH for transmission in the slots n+N to n+2N−1. As another example, when the OCC period includes four slots, i.e., a slot 0 through a slot 3, and the first time period includes the slot 2 and the slot 3, if a is equal to 1 and the PUCCH carrying UCI collides with the PUSCH in the slot 0 or slot 1, the terminal device may multiplex the UCI of the PUCCH onto the PUSCH for transmission in a time period from the slot 2 to the slot 3.

In some implementations, an OCC codeword corresponding to the first time period is different from an OCC codeword corresponding to a second time period, where the second time period is used for transmission of a PUSCH not carrying the aforementioned UCI. For example, a terminal device has an OCC codeword Sᵢ=[s_{i,1}, s_{i,2} . . . s_{i,2N}], the OCC codeword corresponding to the first time period is [s_{i,j}, s_{i,j+1} . . . s_{i,j+N}] (1<j≤N), and the OCC codeword corresponding to the second time period is [s_{i,1}, s_{i,2} . . . s_{i,j-1}], and the OCC codeword corresponding to the first time period differs from the OCC codeword corresponding to the second time period. Because the PUSCH transmitted in the first time period may carry the UCI, the structure of the PUSCH transmitted in the first time period may differ from that of the PUSCH transmitted in the second time period. Using different OCC codewords facilitates successful decoding by the network device of the information sequences carried on the PUSCH.

In some implementations, the second time period is used for transmission of a PUSCH not carrying the aforementioned UCI, which can be understood as a PUSCH onto which UCI from the PUCCH is not multiplexed.

In some implementations, the second time period is earlier than the first time period within the OCC period. For example, when the first time period corresponds to the second half of the OCC period, the second time period corresponds to the first half of the OCC period. As another example, a terminal device has an OCC codeword Sᵢ=[s_{i,1}, s_{i,2} . . . s_{i,2N}], the OCC period has a length of 2N (where N=2⁰, 2¹, 2², . . . ), and the OCC period includes slot indices [n, n+1, . . . , n+2N−1]. If the first time period includes slot indices [n+N, n+N+1, . . . , n+2N−1], then the second time period includes slot indices [n, n+1, . . . , n+N−1]. The OCC codeword corresponding to the first time period is the second half [s_{i,N+1}, s_{i,N+2} . . . s_{i,2N}] of Sᵢ, and the OCC codeword corresponding to the second time period is the first half [s_{i,1}, s_{i,2} . . . s_{i,N}] of Sᵢ, such that the OCC codewords for the first and second time periods are different.

In some implementations, a PUSCH is used to transmit multiple information sequences.

In some implementations, the multiple information sequences may include information sequences that are transmitted on the PUSCH and that carry the aforementioned UCI and/or do not carry it. That is, the multiple information sequences may include information sequences transmitted in the first time period on the PUSCH and/or information sequences transmitted in the second time period on the PUSCH. For example, if a terminal device multiplexes UCI from a PUCCH onto a PUSCH for transmission in the first time period, the information sequence transmitted in the first time period on the PUSCH is X_{1,1}, and the information sequence transmitted in the second time period on the PUSCH is X_{1,0}. The multiple information sequences thus include X_{1,1} and X_{1,0}.

In some implementations, if a terminal device multiplexes UCI from a PUCCH onto a PUSCH for transmission in a first time period, the terminal device performs OCC based on the OCC codeword corresponding to the first time period to generate an information sequence for the PUSCH transmission in the first time period. For example, an i-th terminal device has an OCC codeword Sᵢ=[s_{i,1}, s_{i,2} . . . s_{i,2N}], the OCC period has a length of 2N (where N=2⁰, 2¹, 2², . . . ), and the OCC period includes slot indices [n, n+1, . . . , n+2N−1]. The first time period includes slot indices [n+N, n+N+1, . . . , n+2N−1], and the second time period includes slot indices [n, n+1, . . . , n+N−1]. The OCC codeword corresponding to the first time period is the second half [s_{i,N+1}, s_{i,N+2} . . . s_{i,2N}] of Sᵢ, and the OCC codeword corresponding to the second time period is the first half [s_{i,1}, s_{i,2} . . . s_{i,N}] of Sᵢ. The first indication information is αᵢ, where αᵢ=1, indicating that the i-th terminal device is allowed to multiplex UCI onto the PUSCH for transmission in the first time period. The i-th terminal device performs OCC on sequence information for transmission on the PUSCH based on Sᵢ to generate an information sequence Xᵢ=[x_{i,0}, x_{i,1} . . . x_{i,2N-1}]. If a PUCCH carrying UCI collides with the PUSCH in a slot nₒ(n≤nₒ≤n+N−1) of the second time period, the i-th terminal device multiplexes the UCI from the PUCCH onto the PUSCH in the first time period, and performs OCC based on [s_{i,N+1}, s_{i,N+2} . . . s_{i,2N}] to generate an information sequence [x̅_̅{̅i̅,̅0̅}̅, x̅_̅{̅i̅,̅1̅}̅ . . . x̅_̅{̅i̅,̅N̅-̅1̅}̅] for transmission on the PUSCH in the first time period. The information sequence for transmission on the PUSCH in the second time period is still [x_{i,0}, x_{i,1} . . . x_{i,N-1}]. The i-th terminal device continues to transmit, in slots nₒ+1 through n₀+2N−1, information sequence [x_{i,n}_{ₒ}₊₁, . . . x_{i,N-1}, x̅_̅{̅i̅,̅0̅}̅, x̅_̅{̅i̅,̅1̅}̅ . . . x̅_̅{̅i̅,̅N̅-̅1̅}̅]. Based on this, the information sequence transmitted by the i-th terminal device in the OCC period (slots n through n+2N−1) is Xᵢ=[x_{i,0}, x_{i,1} . . . x_{i,N-1}, x̅_̅{̅i̅,̅0̅}̅, x̅_̅{̅i̅,̅1̅}̅ . . . x̅_̅{̅i̅,̅N̅-̅1̅}̅].

In some other implementations, if the terminal device does not multiplex UCI onto the PUSCH for transmission in the first time period, the terminal device uses all OCC codewords to perform OCC and generates an information sequence for the PUSCH transmission. For example, the OCC codeword for an i-th terminal device may be represented as Sᵢ=[s_{i,1}, s_{i,2} . . . s_{i,2N}], and the OCC period has a length of 2N (N=2⁰, 2¹, 2² . . . ), and the slot indices of the OCC period are [n, n+1, . . . , n+2N−1]. The first indication information, denoted as αᵢ, may be set to zero (αᵢ=0), which indicates that the i-th terminal device is not allowed to multiplex the UCI onto the PUSCH for transmission in the first time period. The i-th terminal device then performs OCC on the information sequence for transmission on the PUSCH based on the codeword Sᵢ, and generates an information sequence Xᵢ=[x_{i,0}, x_{i,1} . . . x_{i,2 N-1}]. Based on this, during the OCC period (from slot n to slot n+2N−1), the i-th terminal device transmits the information sequence Xᵢ=[x_{i,0}, x_{i,1} . . . x_{i,2N-1}].

In some implementations, when a terminal device multiplexes UCI onto a PUSCH for transmission in a first time period, a network device decodes the information sequence transmitted on the PUSCH in the first time period using an OCC codeword corresponding to the first time period, and decodes the information sequence transmitted on the PUSCH in a second time period using an OCC codeword corresponding to the second time period. For example, an OCC codeword for an i-th terminal device may be represented as Sᵢ=[s_{i,1}, s_{i,2} . . . s_{i,2N}], and the OCC period has a length of 2N (where N=2⁰, 2¹, 2², . . . ), and the OCC period includes slot indices [n, n+1, . . . , n+2N−1] (as shown in FIG. 4). The first time period includes slot indices [n+N, n+N+1, . . . , n+2N−1], and the second time period includes slot indices [n, n+1, . . . , n+N−1]. The OCC codeword corresponding to the first time period is the second half [s_{i,N+1}, s_{i,N+2} . . . s_{i,2N}] of Sᵢ, and the OCC codeword corresponding to the second time period is the first half [s_{i,1}, s_{i,2} . . . s_{i,N}] of Sᵢ. Within the OCC period, the PUSCH information sequence received by the network device is [y₀, y₁, . . . , y_{2N-1}] (as shown in FIG. 4). If the i-th terminal device multiplexes UCI onto the PUSCH for transmission in the first time period, the network device performs OCC decoding on the first half of the received information sequence [y₀, y₁, . . . , y_{N-1}] using the codeword [s_{i,1}, s_{i,2} . . . s_{i,N}], and performs OCC decoding on the second half [y_{N}, y_{N+1}, . . . , y_{2N-1}] of the received information sequence using the codeword [s_{i,N+1}, s_{i,N+2} . . . s_{i,2N}], thereby recovering the information sequence of the PUSCH transmission of the i-th terminal device within the OCC period.

In some other implementations, when a terminal device does not multiplex UCI onto a PUSCH for transmission in a first time period, a network device decodes the information sequence of the PUSCH transmission in the OCC period using all OCC codewords of the terminal device. For example, an OCC codeword for an i-th terminal device may be represented as Sᵢ=[s_{i,1}, s_{i,2} . . . s_{i,2N}], and the OCC period has a length of 2N (where N=2⁰, 2¹, 2², . . . ), and the OCC period includes slot indices [n, n+1, . . . , n+2N−1]. Within the OCC period, the PUSCH information sequence received by the network device may be represented as [y₀, y₁, . . . , y_{2N-1}]. If the i-th terminal device does not multiplex UCI onto the PUSCH for transmission in the first time period, the network device performs OCC decoding on the received information sequence [y₀, y₁, . . . , y_{2N-1}] using the codeword [s_{i,1}, s_{i,2} . . . s_{i,2N}], thereby recovering the information sequence of the PUSCH transmission of the i-th terminal device within the OCC period.

In some implementations, based on scheduling information from an access network device and/or based on the first indication information, a network device determines whether a terminal device multiplexes UCI onto a PUSCH for transmission in a first time period.

In some implementations, the scheduling information from the access network device may indicate whether the terminal device is required to multiplex the UCI onto the PUSCH for transmission in the first time period. For example, the access network device triggers an aperiodic CSI transmission, and the scheduling information from the access network device may indicate that the aperiodic CSI is to be transmitted on a PUCCH in a slot of a second time period, and that the terminal device is also required to transmit PUSCH in the same slot. Accordingly, the scheduling information may indicate that the terminal device is required to multiplex the UCI from the PUCCH onto the PUSCH for transmission in the first time period.

In some implementations, the network device determines whether the terminal device multiplexes UCI onto the PUSCH for transmission in the first time period, based on both the scheduling information from the access network device and the first indication information. For example, if the scheduling information from the access network device indicates that the terminal device is required to multiplex UCI onto the PUSCH for transmission, and the first indication information indicates that the terminal device is allowed to multiplex the UCI from the PUCCH onto the PUSCH for transmission in the first time period, then the network device may determine that the terminal device multiplexes the UCI onto the PUSCH for transmission in the first time period.

In some implementations, when the network device successfully decodes multiple information sequences of the PUSCH transmission described above, the network device concatenates the multiple decoded results to obtain a decoded result corresponding to the terminal device. For example, the PUSCH information sequence received by the network device in the OCC period may be represented as [y₀, y₁, . . . , y_{2N-1}], and the first time period corresponds to the second half of the OCC period, and the second time period corresponds to the first half of the OCC period. The network device may perform OCC decoding of the information sequence [y_{N}, y_{N+1}, . . . , y_{2N-1}] of the PUSCH transmission in the first time period using the second half of the OCC codeword for an i-th terminal device, thereby successfully obtaining a decoded result [z_{i,N+1}, z_{i,N+2}, . . . , z_{i,2N}]. The network device may also perform OCC decoding of the information sequence [y₀, y₁, . . . , y_{N-1}] of the PUSCH transmission in the second time period using the first half of the OCC codeword of the i-th terminal device, thereby successfully obtaining a decoded result [z_{i,1}, z_{i,2}, . . . , z_{i,N}]. The network device may then determine a final decoded result corresponding to the i-th terminal device as [z_{i,1}, z_{i,2}, . . . , z_{i,2N}].

In some implementations, when a first information sequence from the multiple information sequences of the PUSCH transmission described above fails to be decoded, the network device records the received information sequence corresponding to the first information sequence. For example, the network device may receive an information sequence [y₀, y₁, . . . , y_{2N-1}], and the first information sequence may be represented as [x̅_̅{̅i̅,̅0̅}̅, x̅_̅{̅i̅,̅1̅}̅ . . . x̅_̅{̅i̅,̅N̅-̅1̅}̅], and is transmitted on the PUSCH in the second half of the OCC period. If the network device fails to decode the information sequence [y_{N}, y_{N+1}, . . . , y_{2N-1}] using the OCC codeword corresponding to [x̅_̅{̅i̅,̅0̅}̅, x̅_̅{̅i̅,̅1̅}̅ . . . x̅_̅{̅i̅,̅N̅-̅1̅}̅], the network device may output a decoding result and record the received information sequence [y_{N}, y_{N+1}, . . . , y_{2N-1}] corresponding to [x̅_̅{̅i̅,̅0̅}̅, x̅_̅{̅i̅,̅1̅}̅ . . . x̅_̅{̅i̅,̅N̅-̅1̅}̅].

In some implementations, when a first information sequence from the multiple information sequences of the PUSCH transmission described above fails to be decoded, the network device may transmit second indication information to the terminal device. The second indication information is configured to instruct the terminal device to retransmit the first information sequence. Accordingly, the terminal device may receive the second indication information and, based on the second indication information, may retransmit the first information sequence to the network device.

In the embodiments of the present application, the first information sequence is not limited. In some embodiments, the first information sequence may correspond to an information sequence of the PUSCH transmission of the terminal device in the first time period. For example, the OCC period has a length of 2N (where N=2⁰, 2¹, 2², . . . ), and the OCC period includes slot indices [n, n+1, . . . , n+2N−1]. The first time period includes slot indices [n+N, n+N+1, . . . , n+2N−1], and the first information sequence may be represented as [x̅_̅{̅i̅,̅0̅}̅, x̅_̅{̅i̅,̅1̅}̅ . . . x̅_̅{̅i̅,̅N̅-̅1̅}̅]. In other embodiments, the first information sequence may correspond to an information sequence of the PUSCH transmission of the terminal device in the second time period. For example, the OCC period has a length of 2N (where N=2⁰, 2¹, 2², . . . ), and the OCC period includes slot indices [n, n+1, . . . , n+2N−1]. The second time period includes slot indices [n, n+1, . . . , n+N−1]. The first information sequence may be represented as [x_{i,0}, x_{i,1} . . . x_{i,N-1}].

In some implementations, the second indication information may be carried in a retransmission scheduling request. For example, the second indication information may be carried in an automatic repeat request ARQ. The network device may transmit an ARQ to the terminal device corresponding to the first information sequence to request the terminal device to retransmit the first information sequence.

In some implementations, the network device may transmit the second indication information based on the received information sequence corresponding to the first information sequence recorded as described above. For example, the first information sequence is [x̅_̅{̅i̅,̅0̅}̅, x̅_̅{̅i̅,̅1̅}̅ . . . x̅_̅{̅i̅,̅N̅-̅1̅}̅], and decoding of the first information sequence fails, the network device may have recorded the received information sequence corresponding to the first information sequence as [y_{N}, y_{N+1}, . . . , y_{2N-1}]. The network device may then transmit the second indication information to the terminal device corresponding to the first information sequence (e.g., an i-th terminal device) based on [y_{N}, y_{N+1}, . . . , y_{2N-1}] and terminal device information (e.g., a terminal device identifier i) corresponding to the first information sequence, thereby requesting the terminal device to retransmit the first information sequence.

In some implementations, the terminal device may retransmit the first information sequence based on the second indication information, where the first information sequence may be carried in a PUSCH information sequence having a length equal to the length of the OCC period. For example, the OCC period has a length of 2N (where N=2⁰, 2¹, 2², . . . ), and the OCC period includes slot indices [n, n+1, . . . , n+2N−1], the first information sequence may be represented as [x̅_̅{̅i̅,̅0̅}̅, x̅_̅{̅i̅,̅1̅}̅ . . . x̅_̅{̅i̅,̅N̅-̅1̅}̅]. To retransmit the first information sequence, the terminal device may transmit a PUSCH information sequence having a length of 2N and including the first information sequence.

In some implementations, if the network device transmits the second indication information to the terminal device and the terminal device retransmits the first information sequence based on the second indication information, the network device may receive the retransmitted information sequence and perform combined decoding on it together with other information sequences that have not been successfully decoded.

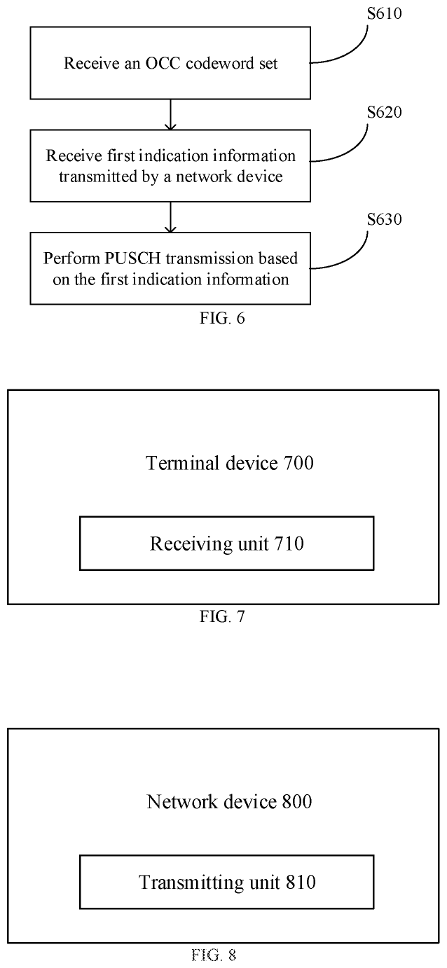

For ease of understanding, by way of example, the following description provides solutions related to the first indication information based on a first embodiment and a second embodiment with reference to FIG. 5 and FIG. 6.

### First Embodiment

Assuming that the number N_{S} of multiplexed terminals is 3, an OCC period has a length of 2N=4, i.e., four slots with indices [0, 1, 2, 3], and an OCC codeword has a length of 4. A first time period corresponds to the second half of the OCC period, and a second time period corresponds to the first half of the OCC period.

Referring to FIG. 5, a solution on the network device side is illustrated, including steps S510 to S530.

In step S510, a network device generates an OCC codeword set.

The network device may generate the OCC codeword set based on the number of multiplexed terminals and the length of the OCC codeword using a Walsh-Hadamard matrix generation method.

$$Idx 1 \text{:} [ \begin{matrix}1 & - 1 & 1 & - 1\end{matrix} ]$$

$$Idx 2 \text{:} [ \begin{matrix}1 & 1 & 1 & 1\end{matrix} ]$$

$$Idx 3 \text{:} [ \begin{matrix}1 & 1 & - 1 & - 1\end{matrix} ]$$

The network device may transmit the OCC codeword set to the terminal devices via an RRC message.

In step S520, the network device may transmit first indication information to the terminal device.

The network device may analyze UCI reporting requirements of each multiplexed terminal device, and determine the first indication information corresponding to each of the terminal devices, which may be represented as [α₁, α₂, α₃]. Here, αᵢ=1 indicates that an i-th terminal device is allowed to multiplex UCI from a PUCCH onto a PUSCH for transmission in the first time period of the OCC period, whereas αᵢ=0 indicates that the i-th terminal device is not allowed to multiplex UCI from the PUCCH onto the PUSCH for transmission in the first time period of the OCC period.

Based on the UCI reporting requirements reported by each of the multiplexed terminal devices, the network device may determine that the UCI reporting requirement of a first terminal device is relatively high, while the UCI reporting requirements of second and third terminal devices are relatively low. Accordingly, the network device may determine the first indication information to be transmitted to the three terminal devices as [α₁, α₂, α₃]=[1,0,0]. That is, the first terminal device is allowed to multiplex UCI from the PUCCH onto the PUSCH for transmission in the first time period of the OCC period, whereas the second and third terminal devices are not allowed to multiplex UCI from the PUCCH onto the PUSCH for transmission in the first time period of the OCC period.

Further, based on the UCI reporting requirements reported by each of the multiplexed terminal devices, the network device may determine to allocate an OCC codeword having a length of 4 to each of the terminal devices. For an i-th terminal device, the OCC codeword may be represented as Sᵢ=[s_{i,1}, s_{i,2} . . . s_{i,2N}].

Since the UCI reporting requirement of the first terminal device is relatively high, and the UCI reporting requirements of the second and third terminal devices are relatively low, the network device may allocate the OCC codewords to the three terminal devices as follows. The OCC codeword for the first terminal device is S₁=[s_{1,1}, s_{1,2}, s_{1,3}, s_{1,4}]=[1 1 −1−1]. The OCC codeword for the second terminal device is S₂=[s_{2,1}, s_{2,2}, s_{2,3}, s_{2,4}]=[1 1 1 1]. The OCC codeword for the third terminal device is S₃=[s_{3,1}, s_{3,2}, s_{3,3}, s_{3,4}]=[1−1 1−1].

The first indication information transmitted by the network device to each of the three terminal devices may be carried in a first signaling. The first signaling may be an RRC message. The first signaling transmitted by the network device to the first terminal device may carry α₁ and the index Idx3 of S₁. The first signaling transmitted by the network device to the second terminal device may carry α₂ and the index Idx2 of S₂. The first signaling transmitted by the network device to the third terminal device may carry α₃ and the index Idx1 of S3.

In step S530, the network device may decode a received information sequence.

A PUSCH information sequence received by the network device in the OCC period with slot indices [0, 1, 2, 3] may be [y₀, y₁, y₂, y₃]. The network device may decode [y₀, y₁, y₂, y₃] according to steps (1) to (6) (not shown in FIG. 5) to recover the transmitted information sequences from each terminal device.

(1) An index i for the terminal devices to be decoded may be initialized to 1.

(2) Based on scheduling information from an access network device and the first indication information transmitted to the terminal devices in step S520, the network device may determine whether UCI multiplexing is present in the information sequence transmitted by an i-th terminal device within the received information sequence [y₀, y₁, y₂, y₃]. If the UCI multiplexing is present, proceed to step (3); otherwise, proceed to step (4).

In case of i=1, if the scheduling information from the access network device indicates that the first terminal device is required to multiplex UCI onto the PUSCH for transmission in the first time period, and a₁ is set to 1, the network device may determine that the UCI multiplexing is present for the first terminal device in [y₂, y₃] of the received sequence [y₀, y₁, y₂, y₃], and therefore may proceed to step (3).

In case of i=2, if the scheduling information from the access network device indicates that the second terminal device is not required to multiplex UCI onto the PUSCH for transmission in the first time period, and α₂ is set to 0, the network device may determine that the UCI multiplexing is not present for the second terminal device in [y₂, y₃] of the received sequence [y₀, y₁, y₂, y₃], and therefore may proceed to step (4).

In case of i=3, if the scheduling information from the access network device indicates that the third terminal device is not required to multiplex UCI onto the PUSCH for transmission in the first time period, and as is set to 0, the network device may determine that the UCI multiplexing is not present for the third terminal device in [y₂, y₃] of the received sequence [y₀, y₁, y₂, y₃], and therefore may proceed to step (4).

(3) the network device may decode the received information sequence [y₂, y₃] corresponding to the first time period using the second half [s_{i,3}, s_{i,4}] of the OCC codeword of the i-th terminal device, resulting in [z_{i,3}, z_{i,4}]; and may decode the received information sequence [y₀, y₁] corresponding to the second time period using the first half [s_{i,1}, s_{i,2}] of OCC codeword of the i-th terminal device, resulting in [z_{i,1}, z_{i,2}]. If both decodings are successful, the network device may output the decoding result for the i-th terminal device as [z_{i,1}, z_{i,2}, z_{i,3}, z_{i,4}]. If only one of the decodings is successful, the network device may output the corresponding decoding result and record the received information sequence that is failed to be decoded. If both decodings fail, the network device may record the received information sequences that are failed to be decoded. After the decodings are completed, i is set to i+1, and proceed to step (5).

In case of i=1, the network device may decode [y₂, y₃] using the second half [s_{1,3}, s_{1,4}]=[−1, −1] of the OCC codeword of the first terminal device, resulting in successful decoding of [z_{1,3}, z_{1,4}]; and may decode [y₀, y₁] using the first half [s_{1,1}, s_{1,2}]=[1,1] of the OCC codeword of the first terminal device, resulting in successful decoding of [z_{1,1}, z_{1,2}]. In the case that both decodings are successful, the decoding result for the first terminal device may be [z_{1,1}, z_{1,2}, z_{1,3}, z_{1,4}]. The value of i may be set to 2, and proceed to step (5).

(4) The network device decodes the information sequence [y₀, y₁, y₂, y₃] using an OCC codeword [s_{i,1}, s_{i,2}, s_{i,3}, s_{i,4}] of the i-th terminal device, resulting in [z_{i,1}, z_{i,2}, z_{i,3}, z_{i,4}]. If the decoding is successful, the decoding result [z_{i,1}, z_{i,2}, z_{i,3}, z_{i,4}] for the i-th terminal device is output. Otherwise, the received information sequence for which the decoding has failed is recorded. Upon completion of the decoding, i is incremented by 1, and proceed to step (5).

In case of i=2, the network device may decode [y₀, y₁, y₂, y₃] using the OCC codeword [s_{2,1}, s_{2,2}, s_{2,3}, s_{2,4}]=[1, 1, 1, 1] of the second terminal device, resulting in successful decoding of [z_{2,1}, z_{2,2}, z_{2,3}, z_{2,4}]. i is set to 3 and the method may proceed to step (5).

In case of i=3, the network device may decode [y₀, y₁, y₂, y₃] using the OCC codeword [s_{3,1}, s_{3,2}, s_{3,3}, s_{3,4}]=[1−1 1−1] of the third terminal device, resulting in successful decoding of [z_{3,1}, z_{3,2}, z_{3,3}, z_{3,4}]. The network device may then set i to 4 and proceed to step (5).

(5) If i=N_{S}+1, the decoding is completed, and proceed to step (6). Otherwise, proceed to step (2).

In case of i=2 or i=3, proceed to step (2). In case of i=4, the decoding is completed, and proceed to step (6).

(6) The network device may check whether there is any failure in the decoding of the first information sequence in step (3) or (4) for each of the terminal devices. If a failure exists, the network device may transmit second indication information to the corresponding terminal device to instruct the terminal device to retransmit the first information sequence.

In the first embodiment, with respect to each of the terminal devices, the decoding is successful, and thus the network device may not need to transmit the second indication information.

Referring to FIG. 6, a solution at the terminal device side is illustrated. FIG. 6 includes steps S610 to S630.

In step S610, a terminal device may receive an OCC codeword set.

The terminal device may receive the OCC codeword set transmitted by a network device and store it for querying in subsequent steps.

In the first embodiment, all three terminal devices may receive the OCC codeword set.

$$Idx 1 \text{:} [ \begin{matrix}1 & - 1 & 1 & - 1\end{matrix} ]$$

$$Idx 2 \text{:} [ \begin{matrix}1 & 1 & 1 & 1\end{matrix} ]$$

$$Idx 3 \text{:} [ \begin{matrix}1 & 1 & - 1 & - 1\end{matrix} ]$$

In step S620, the terminal device may receive first indication information.

Prior to receiving the first indication information, an i-th terminal device may report its UCI reporting requirement to the network device. Subsequently, the i-th terminal device may receive the first indication information αᵢ transmitted by the network device, and may simultaneously receive, via first signaling carrying the first indication information, an OCC codeword index allocated by the network device to the i-th terminal device. By querying the OCC codeword set stored in step S610, the i-th terminal device may obtain its corresponding OCC codeword Sᵢ=[s_{i,1}, s_{i,2}, s_{i,3}, s_{i,4}].

In case of i=1, a first terminal device may transmit, to the network device, its UCI reporting requirement indicating a relatively high UCI reporting demand; subsequently, via the first signaling, the first terminal device may determine that the first indication information α₁=1, which means that the first terminal device is allowed to multiplex UCI from a PUCCH onto a PUSCH for transmission in the first time period of the OCC period, and may simultaneously determine that the index for its OCC codeword S₁ is Idx3, and by querying the OCC codeword set stored in step S610, may obtain the corresponding OCC codeword as S₁=[s_{1,1}, s_{1,2}, s_{1,3}, s_{1,4}]=[1 1−1−1].

In case of i=2, a second terminal device may transmit, to the network device, its UCI reporting requirement indicating a relatively low UCI reporting demand; subsequently, via the first signaling, the second terminal device may determine that the first indication information α₂=0, which means that the second terminal device is not allowed to multiplex UCI from the PUCCH onto the PUSCH for transmission in the first time period of the OCC period, and may simultaneously determine that the index for its OCC codeword is Idx2, and by querying the OCC codeword set stored in step S610, may obtain the corresponding OCC codeword as S₂=[s_{2,1}, s_{2,2}, s_{2,3}, s_{2,4}]=[1 1 1 1].

In case of i=3, a third terminal device may transmit, to the network device, its UCI reporting requirement indicating a relatively low UCI reporting demand; subsequently, via the first signaling, the third terminal device may determine that the first indication information α₃=0, which means that the third terminal device is not allowed to multiplex UCI from the PUCCH onto the PUSCH for transmission in the first time period of the OCC period, and may simultaneously determine that the index for its OCC codeword is Idx1, and by querying the OCC codeword set stored in step S610, may obtain the corresponding OCC codeword as S₃=[s_{3,1}, s_{3,2}, s_{3,3}, s_{3,4}]=[1−1 1−1].

In step S630, the terminal device may perform PUSCH transmission based on the first indication information.

An i-th terminal device may perform OCC on an information sequence for the PUSCH transmission based on Sᵢ, and generate an information sequence Xᵢ=[x_{i,0}, x_{i,1}, x_{i,2}, x_{i,3}] for the PUSCH transmission, which may be transmitted in slots 0 to 3. When the PUCCH carrying UCI collides with the PUSCH in a slot n₀ (0≤n₀≤3), the i-th terminal device may multiplex UCI onto the information sequence Xᵢ for PUSCH according to steps (a) and (b) (not shown in FIG. 6).

In case of i=1, the first terminal device may perform OCC on the information sequence for PUSCH transmission based on S₁=[s_{1,1}, s_{1,2}, s_{1,3}, s_{1,4}]=[1 1 −1 −1], and generate an information sequence X₁=[x_{1,0}, x_{1,1}, x_{1,2}, x_{1,3}] for transmission on PUSCH in slots 0 to 3. With respect to the first terminal device, the PUCCH carrying UCI collides with the PUSCH in slot 0, and the first terminal device may thus proceed to step (a).

In case of i=2, the second terminal device may perform OCC on the information sequence for PUSCH transmission based on S₂=[s_{2,1}, s_{2,2}, s_{2,3}, s_{2,4}]=[1 1 1 1], and generate an information sequence X₂=[x_{2,0}, x_{2,1}, x_{2,2}, x_{2,3}] for transmission on PUSCH in slots 0 to 3. With respect to the second terminal device, no collision occurs between the PUCCH carrying UCI and the PUSCH within the OCC period, and the second terminal device may thus proceed to step (b).

In case of i=3, the third terminal device may perform OCC on the information sequence for PUSCH transmission based on S₃=[s_{3,1}, s_{3,2}, s_{3,3}, s_{3,4}]=[1 −1 1 −1], and generate an information sequence X₃=[x_{3,0}, x_{3,1}, x_{3,2}, x_{3,3}] for transmission on PUSCH in slots 0 to 3. With respect to the third terminal device, no collision occurs between the PUCCH carrying UCI and the PUSCH within the OCC period, and the third terminal device may thus proceed to step (b).

(a) If αᵢ=1 and n₀ (0≤n₀≤1), the i-th terminal device may multiplex UCI from the PUCCH onto the PUSCH in the first time period (slots 2 to 3). The i-th terminal device may perform OCC based on the second half [s_{i,3}, s_{i,4}] of its OCC codeword Sᵢ to generate an information sequence [x̅_̅{̅i̅,̅0̅}̅, x̅_̅{̅i̅,̅1̅}̅] The i-th terminal device may continue transmitting [x_{i,n}_{₀}₊₁, x̅_̅{̅i̅,̅0̅}̅, x̅_̅{̅i̅,̅1̅}̅ ] in slots n₀+1 to 3. Accordingly, the information sequence of the i-th terminal device for PUSCH transmission in slots 0 to 3 may be expressed as Xᵢ=[x_{i,0}, x_{i,1}, x̅_̅{̅i̅,̅0̅}̅, x̅_̅{̅i̅,̅1̅}̅].

If i=1, α₁=1 and n₀=0, the first terminal device may multiplex UCI from the PUCCH onto the PUSCH in time slots 2 to 3. The first terminal device may perform OCC based on the second half [1, −1] of its OCC codeword Sᵢ to generate an information sequence [x̅_̅{̅1̅,̅0̅}̅, x̅_̅{̅1̅,̅1̅}̅]. The first terminal device may continue transmitting [x_{1,1}, x̅_̅{̅1̅,̅0̅}̅, x̅_̅{̅1̅,̅1̅}̅] in slots 1 to 3. Accordingly, the information sequence of the first terminal device for PUSCH transmission in slots 0 to 3 may be expressed as X₁=[x_{1,0}, x_{1,1}, x̅_̅{̅1̅,̅0̅}̅, x̅_̅{̅1̅,̅1̅}̅].

(b) Otherwise, the i-th terminal device may not multiplex UCI from the PUCCH onto the PUSCH in the first time period (slots 2 to 3). Accordingly, the information sequence of the i-th terminal device for the PUSCH transmission in slots 0 to 3 may be expressed as Xᵢ=[x_{i,0}, x_{i,1}, x_{i,2}, x_{i,3}].

In case of i=2, and α₂=0, the second terminal device may not multiplex UCI from the PUCCH onto the PUSCH in slots 2 to 3. Accordingly, the information sequence of the second terminal device for PUSCH transmission in slots 0 to 3 may be expressed as X₂=[x_{2,0}, x_{2,1}, x_{2,2}, x_{2,3}].

In case of i=3, and α₃=0, the third terminal device may not multiplex UCI from the PUCCH onto the PUSCH in slots 2 to 3. Accordingly, the information sequence of the third terminal device for PUSCH transmission in slots 0 to 3 may be expressed as X₃=[x_{3,0}, x_{3,1}, x_{3,2}, x_{3,3}].

### Second Embodiment

Assuming that the number N_{S} of multiplexed terminals is 2, an OCC period has a length of 2N=4, i.e., four slots with indices [0, 1, 2, 3], and an OCC codeword has a length of 4. A first time period corresponds to the second half of the OCC period, and a second time period corresponds to the first half of the OCC period.

Referring to FIG. 5, a solution on the network device side is illustrated. FIG. 5 includes steps S510 to S530.

In step S510, a network device generates an OCC codeword set.

The network device may generate the OCC codeword set according to the number of multiplexed terminals and the length of the OCC codeword, using a Walsh-Hadamard matrix generation method.

$$Idx 1 \text{:} [ \begin{matrix}1 & - 1 & 1 & - 1\end{matrix} ]$$

$$Idx 2 \text{:} [ \begin{matrix}1 & 1 & - 1 & - 1\end{matrix} ]$$

The network device may transmit the OCC codeword set to the terminal devices via an RRC message.

In step S520, the network device transmits first indication information to the terminal devices.

The network device may analyze UCI reporting requirements of each multiplexed terminal device, and determine the first indication information corresponding to each of the terminal devices, which may be expressed as [α₁, α₂]. Here, αᵢ=1 indicates that an i-th terminal device is allowed to multiplex UCI from a PUCCH onto a PUSCH transmission in the first time period of the OCC period, whereas αᵢ=0 indicates that the i-th terminal device is not allowed to multiplex UCI from the PUCCH onto the PUSCH for transmission in the first time period of the OCC period.

Based on the UCI reporting requirements reported by each of the multiplexed terminals, the network device may determine that both a first terminal device and a second terminal device have relatively high UCI reporting requirements. Accordingly, the network device may determine that the first indication information to be transmitted to the two terminal devices is [α₁, α₂]=[1, 1]. That is, both the first and second terminal devices are allowed to multiplex UCI from the PUCCH onto the PUSCH for transmission in the first time period of the OCC period.

Further, based on the UCI reporting requirements reported by each of the multiplexed terminal devices, the network device may determine to allocate an OCC codeword having a length of 4 to each of the terminal devices. For an i-th terminal device, the OCC codeword may be represented as Sᵢ=[s_{i,1}, s_{i,2} . . . s_{i,2N}].

Since the UCI reporting requirement of the second terminal device is higher than that of the first terminal device, the network device may allocate the OCC codewords to the two terminal devices as follows. The OCC codeword for the first terminal device is S₁=[s_{1,1}, s_{1,2}, s_{1,3}, s_{1,4}]=[1 −1 1 −1], and the OCC codeword for the second terminal device is S₂=[s_{2,1}, s_{2,2}, s_{2,3}, s_{2,4}]=[1 1 −1 −1].

The first indication information transmitted by the network device to each of the two terminal devices is carried in a first signaling. The first signaling is an RRC message. The first signaling transmitted by the network device to the first terminal device may carry α₁ and the index Idx1 of S₁. The first signaling transmitted by the network device to the second terminal device may carry α₂ and the index Idx2 of S₂.

In step S530, the network device may decode the received information sequence.

A PUSCH information sequence received by the network device in the OCC period with slot indices [0, 1, 2, 3] may be [y₀, y₁, y₂, y₃]. The network device may decode [y₀, y₁, y₂, y₃] according to steps (1) to (6) (not shown in FIG. 5) to recover the transmitted information sequences from each terminal device.

(1) An index i for the terminal devices to be decoded may be initialized to 1.

(2) Based on scheduling information from an access network device and the first indication information [α₁, α₂] sent to the terminal devices in step S520, the network device may determine whether UCI multiplexing is present in the information sequence transmitted by an i-th terminal device within the received information sequence [y₀, y₁, y₂, y₃]. If the UCI multiplexing is present, proceed to step (3); otherwise, proceed to step (4).

In case of i=1, if the scheduling information from the access network device indicates that the first terminal device is required to multiplex UCI onto the PUSCH for transmission in the first time period, and α₁ is set to 1, the network device may determine that the UCI multiplexing is present for the first terminal device in [y₂, y₃] of the received information sequence [y₀, y₁, y₂, y₃], and therefore proceeds to step (3).

In case of i=2, if the scheduling information from the access network device indicates that the second terminal device is required to multiplex UCI onto the PUSCH for transmission in the first time period, and az is set to 1, the network device may determine that the UCI multiplexing is present for the second terminal device in [y₂, y₃] of the received information sequence [y₀, y₁, y₂, y₃], and therefore proceeds to Step (3).

(3) The network device may decode the received information sequence [y₂, y₃] corresponding to the first time period using the second half [s_{i,3}, s_{i,4}] of the OCC codeword of the i-th terminal device, resulting in [z_{i,3}, z_{i,4}]; and may decode the received information sequence [y₀, y₁] corresponding to the second time period using the first half [s_{i,1}, s_{i,2}] of the OCC codeword of the i-th terminal device, resulting in [z_{i,1}, z_{i,2}]. If both decodings are successful, the network device may output the decoding result for the i-th terminal device as [z_{i,1}, z_{i,2}, z_{i,3}, z_{i,4}]. If only one of the decodings is successful, the network device may output the corresponding decoding result and record the received information sequence that is failed to be decoded. If both decodings fail, the network device may record the received information sequences that are failed to be decoded. After the decodings are completed, i is set to i+1, and proceed to step (5).

In case of i=1, the network device may decode [y₂, y₃] using the second half [s_{1,3}, s_{1,4}]=[1, −1] of the OCC codeword of the first terminal device, resulting in successful decoding of [z_{1,3}, z_{1,4}]; and may decode [y₀, y₁] using the first half [s_{1,1}, s_{1,2}]=[1, −1] of the OCC codeword of the first terminal device, resulting in successful decoding of [z_{1,1}, z_{1,2}]. In the case that both decodings are successful, the decoding result for the first terminal device may be [z_{1,1}, z_{1,2}, z_{1,3}, z_{1,4}]. The value of i may be set to 2, and proceed to step (5).

In case of i=2, the network device may decode [y₂, y₃] using the second half [s_{2,3}, s_{2,4}]=[−1, −1] of the OCC codeword of the second terminal device, and the decoding fails; the network device may decode [y₀, y₁] using the first half [s_{2,1}, s_{2,2}]=[1, 1] of the OCC codeword of the second terminal device, resulting in successful decoding of [z_{2,1}, z_{2,2}]. The network device may record the information sequence [y₂, y₃] that is failed to be decoded. The value of i may be set to 3, and proceed to step (5).

(4) The network device decodes the information sequence [y₀, y₁, y₂, y₃] using the OCC codeword [s_{i,1}, s_{i,2}, s_{i,3}, s_{i,4}] of the i-th terminal device, resulting in [z_{i,1}, z_{i,2}, z_{i,3}, z_{i,4}]. If the decoding is successful, the decoding result [z_{i,1}, z_{i,2}, z_{i,3}, z_{i,4}] for the i-th terminal device is output. Otherwise, the received information sequence for which the decoding has failed is recorded. Upon completion of the decoding, i is incremented by 1, and proceed to step (5).

In the second embodiment, the network device is not required to perform this step (4).

(5) If i=N_{S}+1, the decoding is completed and proceed to step (6). Otherwise, proceed to step (2).

In case of i=2, proceed to step (2). In case of i=3, the decoding is completed, and proceed to step (6).

(6) The network device may check whether there is any failure in the decoding of the first information sequence in step (3) or step (4) for each of the terminal devices. If a failure exists, the network device may transmit second indication information to the corresponding terminal device to instruct the terminal device to retransmit the first information sequence.

In the second embodiment, the network device fails to decode [y₂, y₃] using the OCC codeword of the second terminal device. Accordingly, the network device transmits second indication information to the second terminal device, instructing the second terminal device to transmit a PUSCH information sequence having a length of 4. The PUSCH information sequence includes a first information sequence corresponding to [y₂, y₃], namely [x̅_̅{̅2̅,̅0̅}̅, x̅_̅{̅2̅,̅1̅}̅]. The network device then decodes a received retransmission information sequence [y₂, y₃, y₂, y₃] using S₂=[s_{2,1}, s_{2,2}, s_{2,3}, s_{2,4}]=[1 1 −1 −1], and after the receiving, perform combined decoding on it together with the information sequence successfully decoded in step (3).

Referring to FIG. 6, a solution at the terminal device side is illustrated. FIG. 6 includes steps S610 through S630.

In step S610, a terminal device may receive an OCC codeword set.

The terminal device may receive the OCC codeword set transmitted by a network device and store the OCC codeword set for querying in subsequent steps.

In the second embodiment, two terminal devices each receive the OCC codeword set.

$$Idx 1 \text{:} [ \begin{matrix}1 & - 1 & 1 & - 1\end{matrix} ]$$

$$Idx 2 \text{:} [ \begin{matrix}1 & 1 & - 1 & - 1\end{matrix} ]$$

In step S620, the terminal device may receive first indication information.

Prior to receiving the first indication information, an i-th terminal device may report its UCI reporting requirement to the network device. Subsequently, the i-th terminal device may receive the first indication information di transmitted by the network device, and may simultaneously receive, via first signaling carrying the first indication information, an OCC codeword index allocated by the network device to the i-th terminal device. By querying the OCC codeword set stored in step S610, the i-th terminal device may obtain the corresponding OCC codeword Sᵢ=[s_{i,1}, s_{i,2}, s_{i,3}, s_{i,4}].

In case of i=1, a first terminal device transmits, to the network device, its UCI reporting requirement indicating a relatively high UCI reporting demand; subsequently, via the first signaling, the first terminal device may determine that the first indication information α₁=1, which means that the first terminal device is allowed to multiplex UCI from a PUCCH onto a PUSCH for transmission in the first time period of the OCC period, and may simultaneously determine that the index for its OCC codeword S₁ is Idx1, and by querying the OCC codeword set stored in step S610, may obtain the corresponding OCC codeword as S₁=[s_{1,1}, s_{1,2}, s_{1,3}, s_{1,4}]=[1 1 −1 −1].

In case of i=2, a second terminal device transmits, to the network device, its UCI reporting requirement indicating a relatively high UCI reporting demand; subsequently, via the first signaling, the second terminal device may determine that the first indication information α₂=1, which means that the second terminal device is allowed to multiplex UCI from the PUCCH onto the PUSCH for transmission in the first time period of the OCC period, and may simultaneously determine that the index for its OCC codeword S₂ is Idx2, and by querying the OCC codeword set stored in step S610, may obtain the corresponding OCC codeword as S₂=[s_{2,1}, s_{2,2}, s_{2,3}, s_{2,4}]=[1 1 −1 −1].

In step S630, the terminal device may perform PUSCH transmission based on the first indication information.

An i-th terminal device may perform OCC on an information sequence for the PUSCH transmission based on Sᵢ, and generate an information sequence Xᵢ=[x_{i,0}, x_{i,1}, x_{i,2}, x_{i,3}] for the PUSCH transmission, which may be transmitted in slots 0 to 3. When the PUCCH carrying UCI collides with the PUSCH in a slot n₀ (0≤n₀≤3), the i-th terminal device may multiplex UCI onto the information sequence Xᵢ for PUSCH according to steps (a) and (b) (not shown in FIG. 6).

In case of i=1, the first terminal device may perform OCC on the information sequence for PUSCH transmission based on S₁=[s_{1,1}, s_{1,2}, s_{1,3}, s_{1,4}]=[1 −1 1 −1], and generate an information sequence X₁=[x_{1,0}, x_{1,1}, x_{1,2}, x_{1,3}] for transmission on PUSCH in slots 0 to 3. With respect to the first terminal device, the PUCCH carrying UCI collides with the PUSCH in slot 0, and the first terminal device may thus proceed to step (a).

In case of i=2, the second terminal device may perform OCC on the information sequence for PUSCH transmission based on S₂=[s_{2,1}, s_{2,2}, s_{2,3}, s_{2,4}]=[1 −1 1 −1], and generate an information sequence X₂=[x_{2,0}, x_{2,1}, x_{2,2}, x_{2,3}] for transmission on PUSCH in slots 0 to 3. With respect to the second terminal device, the PUCCH carrying UCI collides with the PUSCH in slot 1, and the second terminal device may thus proceed to step (a).

(a) If αᵢ=1 and n₀ (0≤n₀≤1), the i-th terminal device may multiplex UCI from the PUCCH onto the PUSCH in the first time period (slots 2 to 3). The i-th terminal device may perform OCC based on the second half [s_{i,3}, s_{i,4}] of its OCC codeword Sᵢ to generate an information sequence [x̅_̅{̅i̅,̅0̅}̅, x̅_̅{̅i̅,̅1̅}̅]. The i-th terminal device may continue transmitting [x_{i,n}_{₀}₊₁, x̅_̅{̅i̅,̅0̅}̅, x̅_̅{̅i̅,̅1̅}̅] in slots n₀+1 to 3. Accordingly, the information sequence of the i-th terminal device for PUSCH transmission in slots 0 to 3 may be expressed as Xᵢ=[x_{i,0}, x_{i,1}, x̅_̅{̅i̅,̅0̅}̅, x̅_̅{̅i̅,̅1̅}̅].

If i=1, α₁=1, and n₀=0, the first terminal device may multiplex UCI from the PUCCH onto the PUSCH in time slots 2 to 3. The first terminal device may perform OCC based on the second half [s_{i,3}, s_{i,4}] of its OCC codeword S₁ to generate an information sequence [x̅_̅{̅1̅,̅0̅}̅, x̅_̅{̅1̅,̅1̅}̅]. The first terminal device may continue transmitting [x_{1,1}, x̅_̅{̅1̅,̅0̅}̅, x̅_̅{̅1̅,̅1̅}̅] in slots 1 to 3. Accordingly, the information sequence of the first terminal device for PUSCH transmission in slots 0 to 3 may be expressed as X₁=[x_{1,0}, x_{1,1}, x̅_̅{̅1̅,̅0̅}̅, x̅_̅{̅1̅,̅1̅}̅].

If i=2, α₁=1, and n₀=1, the first terminal device may multiplex UCI from the PUCCH onto the PUSCH in time slots 2 to 3. The first terminal device may perform OCC based on the second half [s_{i,3}, s_{i,4}] of its OCC codeword S₁ to generate an information sequence [x̅_̅{̅1̅,̅0̅}̅, x̅_̅{̅1̅,̅1̅}̅]. The first terminal device may continue transmitting [x_{1,1}, x̅_̅{̅1̅,̅0̅}̅, x̅_̅{̅1̅,̅1̅}̅] in slots 1 to 3. Accordingly, the information sequence of the first terminal device for PUSCH transmission in slots 0 to 3 may be expressed as X₂=[x_{2,0}, x_{2,1}, x̅_̅{̅2̅,̅0̅}̅, x̅_̅{̅2̅,̅1̅}̅].

(b) Otherwise, the i-th terminal device may not multiplex UCI from the PUCCH onto the PUSCH in the first time period (slots 2 to 3). Based on this, the information sequence of the i-th terminal device for the PUSCH transmission in slots 0 to 3 may be expressed as Xᵢ=[x_{i,0}, x_{i,1}, x_{i,2}, x_{i,3}].

In the second embodiment, the first terminal device and the second terminal device do not perform this step (b).

The method embodiments of the present disclosure have been described in detail above with reference to FIGS. 1 to 6. The apparatus embodiments of the present disclosure will be described in detail below with reference to FIGS. 7 to 9. It should be understood that the description of the method embodiments corresponds to the description of the apparatus embodiments, and therefore, the parts that are not described in detail may refer to the preceding method embodiments.

FIG. 7 is a schematic diagram illustrating a terminal device according to an embodiment of the present disclosure. The terminal device 700 shown in FIG. 7 includes: a receiving unit 710.

The receiving unit 710 is configured to receive first indication information transmitted by a network device, where the first indication information is used to indicate whether the terminal device is allowed to multiplex uplink control information (UCI) from a physical uplink control channel (PUCCH) onto a physical uplink shared channel (PUSCH) for transmission in a first time period of an orthogonal cover code (OCC) period.

In some implementations, a time when the PUCCH collides with the PUSCH is within the OCC period, and earlier than the first time period.

In some implementations, the terminal device further includes: a transmitting unit, configured to, in response to the first indication information indicating that the terminal device is allowed to multiplex the UCI onto the PUSCH for transmission in the first time period, multiplex the UCI onto the PUSCH for transmission in the first time period.

In some implementations, an OCC codeword corresponding to the first time period is different from an OCC codeword corresponding to a second time period, and the second time period is used for transmission of a PUSCH not carrying the UCI.

In some implementations, the second time period is earlier than the first time period within the OCC period.

In some implementations, the PUSCH is used to transmit a plurality of information sequences, and the receiving unit 710 is further configured to, when a first information sequence from the plurality of information sequences fails to be decoded, receive second indication information transmitted by the network device, where the second indication information is used to instruct the terminal device to retransmit the first information sequence.

In some implementations, the first time period corresponds to a second half of the OCC period.

FIG. 8 is a schematic diagram of a network device according to an embodiment of the present disclosure. The network device 800 shown in FIG. 8 includes: a transmitting unit 810.

The transmitting unit 810 is configured to transmit first indication information to a terminal device, where the first indication information is used to indicate whether the terminal device is allowed to multiplex uplink control information (UCI) from a physical uplink control channel (PUCCH) onto a physical uplink shared channel (PUSCH) for transmission in a first time period of an orthogonal cover code (OCC) period.

In some implementations, a time when the PUCCH collides with the PUSCH is located within the OCC period and earlier than the first time period.

In some implementations, an OCC codeword corresponding to the first time period is different from an OCC codeword corresponding to the second time period, and the second time period is used for transmission of a PUSCH not carrying the UCI.

In some implementations, the second time period is earlier than the first time period within the OCC period.

In some implementations, the PUSCH is used to transmit a plurality of information sequences, and the transmitting unit 810 is further configured to, when a first information sequence from the multiple information sequences fails to be decoded, transmit second indication information to the terminal device, where the second indication information is used to instruct the terminal device to retransmit the first information sequence.

In some implementations, the first time period corresponds to a second half of the OCC period.

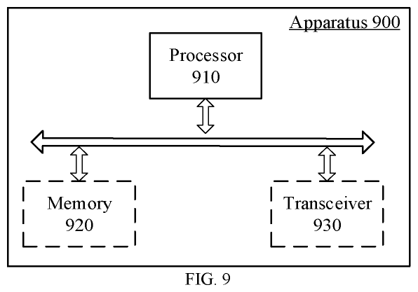

In an optional embodiment, the receiving unit 710 may be a transceiver 930. The terminal device 700 may further include a processor 910 and a memory 920, as shown in FIG. 9.

In an optional embodiment, the transmitting unit 810 may be a transceiver 930. The network device 800 may further include a processor 910 and a memory 920, as shown in FIG. 9.

FIG. 9 is a schematic structural diagram of a communications apparatus according to an embodiment of the present disclosure. The dashed lines in FIG. 9 indicate that the unit or module is optional. The apparatus 900 may be used to implement the methods described in the above method embodiments. The apparatus 900 may be a chip, a terminal device, or a network device.

The apparatus 900 may include one or more processors 910. The processor 910 is configured to support the apparatus 900 in performing the methods described in the foregoing method embodiments. The processor 910 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or other programmable logic device, a discrete gate or transistor logic device, a discrete hardware components, or the like. The general-purpose processor may be a microprocessor or any conventional processor.

The apparatus 900 may further include one or more memories 920. The memory 920 stores a program that can be executed by the processor 910, to cause the processor 910 to perform the methods described in the foregoing method embodiments. The memory 920 may be independent of the processor 910 or integrated within the processor 910.

The apparatus 900 may further include a transceiver 930. The processor 910 can communicate with other devices or chips via the transceiver 930. For example, the processor 910 can transmit or receive data to or from other devices or chips through the transceiver 930.

An embodiment of the present disclosure also provides a computer-readable storage medium for storing a program. The computer-readable storage medium may be applied to the terminal device or network device provided in the embodiments of the present disclosure, and the program enables a computer to execute the methods performed by the terminal device or network device in various embodiments of the present disclosure.

An embodiment of the present application also provides a computer program product. The computer program product includes a program, which may be applied to the terminal device or network device in the embodiments of the present disclosure, and the program enables a computer to execute the method performed by the terminal device or network device in various embodiments of the present disclosure.

An embodiment of the present application also provides a computer program. The computer program may be applied to the terminal device or network device provided in the embodiments of the present disclosure, and the program enables a computer to execute the method performed by the terminal device or network device in various embodiments of the present disclosure.

It should be understood that the terms “system” and “network” used in the present application can be used interchangeably. Moreover, the terminology used in the present application is only intended to describe specific embodiments of the present application, and is not intended to limit the present application. The terms “first,” “second,” “third,” and “fourth” in the specification, claims, and drawings of the present application are used to distinguish different objects and are not intended to indicate a particular order. In addition, the terms “comprising” and “having,” as well as any variations thereof, are intended to cover non-exclusive inclusions.

In the embodiments of the present application, the term “indicate” may refer to a direct indication, an indirect indication, or an indication of association. For example, A indicates B may mean that A directly indicates B, for example, B can be obtained from A; or that A indirectly indicates B, for example, A indicates C and B can be obtained from C; or that A and B have an association relationship.

In the embodiments of the present application, the term “corresponding” may refer to a direct or indirect correspondence relationship, an association relationship, or a relationship such as indicating and being indicated, configuring and being configured, etc.

In the embodiments of the present application, the term “and/or” merely describes a relationship between associated objects, indicating that three situations may exist. For example, “A and/or B” may indicate: only A exists, both A and B exist, or only B exists. Moreover, the character “/” generally indicates an “or” relationship between the objects before and after it.

In the various embodiments of the present application, the numerical order of the above-mentioned processes does not imply the execution sequence. The execution order of each process should be determined according to its function and intrinsic logic, and should not impose any limitation on the implementation of the embodiments of the present application.

It should be understood that the systems, devices, and methods disclosed in the embodiments of the present application may be implemented in other ways. For example, the device embodiments described above are merely exemplary. The division of units is only a logical functional division. In actual implementation, there may be other division methods, such as multiple units or components being combined or integrated into another system, or some features may be omitted or not executed. In addition, the coupling or direct coupling or communication connections discussed or shown may be via interfaces, and indirect coupling or communication connections between devices or units may be electrical, mechanical, or in other forms.

The units described as separate components may or may not be physically separated. The components shown as units may or may not be physical units, i.e., they may be located in one place or distributed across multiple network units. Some or all units may be selected according to actual needs to achieve the objectives of the embodiments.

Furthermore, the functional units in the embodiments of the present application may be integrated into one processing unit, or each unit may exist separately in physical form, or two or more units may be integrated into one unit.

In the above embodiments, the implementations may be fully or partially realized by software, hardware, firmware, or any combination thereof. When implemented in software, the implementation may be fully or partially realized in the form of a computer program product. The computer program product includes one or more computer instructions. When the computer program instructions are loaded and executed on a computer, all or part of the processes or functions described in the embodiments of the present application are performed. The computer may be a general-purpose computer, a dedicated computer, a computer network, or other programmable apparatus. The computer instructions may be stored in a computer-readable storage medium, or transmitted from one computer-readable storage medium to another, for example, from a website, computer, server, or data center to another website, computer, server, or data center via a wired medium (such as coaxial cable, optical fiber, digital subscriber line (DSL)) or a wireless medium (such as infrared, radio, microwave, etc.). The computer-readable storage medium may be any available medium that can be read by a computer, or a data storage device such as a server or data center including one or more available media. The available medium may be a magnetic medium (e.g., floppy disk, hard disk, magnetic tape), an optical medium (e.g., digital video disc (DVD)), or a semiconductor medium (e.g., solid-state disk (SSD)), and so on.

The above descriptions are merely specific embodiments of the present application, and the protection scope of the present application is not limited thereto. Any person skilled in the art may easily conceive variations or substitutions within the technical scope disclosed in the present application, which should be encompassed within the protection scope of the present application. Therefore, the protection scope of the present application should be determined by the scope of the claims.

What is claimed is:

1. A method for wireless communication, comprising:
receiving, by a terminal device, first indication information transmitted by a network device, the first indication information being used to indicate whether the terminal device is allowed to multiplex uplink control information (UCI) from a physical uplink control channel (PUCCH) onto a physical uplink shared channel (PUSCH) for transmission in a first time period of an orthogonal cover code (OCC) period.

2. The method according to claim 1, wherein a time when the PUCCH collides with the PUSCH is within the OCC period and is earlier than the first time period.

3. The method according to claim 1, further comprising:
multiplexing, by the terminal device in response to the first indication information indicating that the terminal device is allowed to multiplex the UCI onto the PUSCH for transmission in the first time period, the UCI onto the PUSCH for transmission in the first time period.

4. The method according to claim 1, wherein an OCC codeword corresponding to the first time period is different from an OCC codeword corresponding to a second time period, the second time period being used for transmission of a PUSCH not carrying the UCI.

5. The method according to claim 4, wherein the second time period is earlier than the first time period within the OCC period.

6. The method according to claim 1, wherein the PUSCH is used to transmit a plurality of information sequences, and the method further comprises:
receiving, by the terminal device in response to a first information sequence from the plurality of information sequences failing to be decoded, second indication information transmitted by the network device, the second indication information being used to instruct the terminal device to retransmit the first information sequence.

7. The method according to claim 1, wherein the first time period is a second half of the OCC period.

8. A method for wireless communication, comprising:
transmitting, by a network device, first indication information to a terminal device, the first indication information being used to indicate whether the terminal device is allowed to multiplex uplink control information (UCI) from a physical uplink control channel (PUCCH) onto a physical uplink shared channel (PUSCH) for transmission in a first time period of an orthogonal cover code (OCC) period.

9. The method according to claim 8, wherein a time when the PUCCH collides with the PUSCH is within the OCC period and is earlier than the first time period.

10. The method according to claim 8, wherein an OCC codeword corresponding to the first time period is different from an OCC codeword corresponding to a second time period, the second time period being used for transmission of a PUSCH not carrying the UCI.

11. The method according to claim 10, wherein the second time period is earlier than the first time period within the OCC period.

12. The method according to claim 8, wherein the PUSCH is used to transmit a plurality of information sequences, and the method further comprises:
transmitting, by the network device in response to a first information sequence from the plurality of information sequences failing to be decoded, second indication information to the terminal device, the second indication information being used to instruct the terminal device to retransmit the first information sequence.

13. The method according to claim 8, wherein the first time period is a second half of the OCC period.

14. A terminal device, comprising a transceiver, a memory, and a processor, wherein the memory is configured to store a program, and the processor is configured to invoke the program stored in the memory and control the transceiver to receive or transmit a signal to cause the terminal device to perform following operation:
receiving first indication information transmitted by a network device, the first indication information being used to indicate whether the terminal device is allowed to multiplex uplink control information (UCI) from a physical uplink control channel (PUCCH) onto a physical uplink shared channel (PUSCH) for transmission in a first time period of an orthogonal cover code (OCC) period.

15. The terminal device according to claim 14, wherein a time when the PUCCH collides with the PUSCH is within the OCC period and is earlier than the first time period.

16. The terminal device according to claim 14, wherein the terminal device further performs following operation:
multiplexing, in response to the first indication information indicating that the terminal device is allowed to multiplex the UCI onto the PUSCH for transmission in the first time period, the UCI onto the PUSCH for transmission in the first time period.

17. The terminal device according to claim 14, wherein an OCC codeword corresponding to the first time period is different from an OCC codeword corresponding to a second time period, the second time period being used for transmission of a PUSCH not carrying the UCI.

18. The terminal device according to claim 17, wherein the second time period is earlier than the first time period within the OCC period.

19. The terminal device according to claim 14, wherein the PUSCH is used to transmit a plurality of information sequences, and the terminal device further performs following operation:
receiving, in response to a first information sequence from the plurality of information sequences failing to be decoded, second indication information transmitted by the network device, the second indication information being used to instruct the terminal device to retransmit the first information sequence.

20. The terminal device according to claim 14, wherein the first time period is a second half of the OCC period.
